(19) United States
(12) Patent Application Publication
(10) Pub. No.: US 2015/0128145 A1
(43) Pub. Date: May 7, 2015

(54) SYSTEM AND METHOD FOR ROUTING WORK REQUESTS TO MINIMIZE ENERGY COSTS IN A DISTRIBUTED COMPUTING SYSTEM

(71) Applicant: Avaya Inc., Basking Ridge, NJ (US)

(72) Inventors: Joseph Smyth, Galway (IE); Paul D'Arcy, Limerick (IE); Neil O'Connor, Galway (IE); Dawid Nowak, Dublin (IE); Tony McCormack, Galway (IE)

(73) Assignee: Avaya Inc., Basking Ridge, NJ (US)

(21) Appl. No.: 14/072,212

(22) Filed: Nov. 5, 2013

(51) Int. Cl. G06F 9/48

(52) U.S. Cl. CPC G06F 9/4893
USPC 718/104

(57) ABSTRACT

A system for automated routing or work requests is provided. Particularly, a system for routing work requests in a distributed computing system to minimize an energy cost associated with operating the system is provided. A resource utilization module configured to receive resource utilization information; the resource utilization information including indications of utilization corresponding to a plurality of computing resources is disclosed. Furthermore, an energy consumption module configured to receive energy consumption information; the energy consumption information including indications of energy consumption corresponding to the plurality of computing resources is disclosed. Additionally, a routing module configured to route a work request to one of the plurality of computing resources based at least in part on the received utilization information and the received energy consumption information to minimize energy costs of the plurality of computing resources is disclosed.

### BACKGROUND

1. Field of the Invention

Embodiments of the present disclosure generally relate to a system and method for routing work requests in a distributed computing system. More specifically, embodiments of the present disclosure provide a system and method for routing work requests in a distributed computing system to minimize energy costs of the system.

2. Description of Related Art

Electricity accounts for a large portion of the costs to operate computing resources (e.g., computers, servers, or the like). In particular, distributed computing systems (e.g., those including multiple computing resources) often consume large amounts of energy during operation. Additionally, such computing systems often require many auxiliary systems (e.g., cooling, noise abatement, operator personnel, etc.), which also consume large amounts of energy while supporting the computing system. In some examples, electricity costs may account for as much as 20% of the total budget for operating these computing systems. Accordingly, reducing the energy consumption of distributed computing systems can result in a significant cost savings in addition to providing for a more efficient and “green” utilization of resources.

A variety of power management tools are available to assist in reducing the energy consumed by a computing resource. For example, dynamic power management (DPM) and dynamic resource scheduler (DRS) are software programs that operate to reduce the power consumption of a computing resource. Power management tools often allow the computing resource or portions of the computing resource to be powered down to reduce energy consumption. As another example, a virtual machine could be relocated from one computing resource to another to reduce energy consumption. Accordingly, each computing resource may be allowed to individually manage its power consumption to minimize energy costs.

For some distributed computing systems, however, it may be necessary to prevent the computing resources within the system from individually managing their power consumption. For example, some distributed computing systems must often maintain extra capacity to accommodate increased needs of the system or to accommodate failures within portions of the system without such failures resulting in a system wide failure. As such, each individual computing resource within the system might be prevented from using various power management features in order to ensure the computing resources are available if needed to support increased demand or maintain redundancy for system failures.

Thus there is a need for a system and method for routing work requests in a distributed computing system that minimizes the energy costs of the system. Additionally, there is a need for a system and method that dynamically manages power consumption features of computing resources in the system while accounting for system wide needs.

### SUMMARY

Embodiments in accordance with the present invention provide a system for automated routing of work requests to computing resources in a distributed computing system. The system includes a resource utilization module configured to receive resource utilization information, the resource utilization information including indications of utilization corresponding to a plurality of computing resources, an energy consumption module configured to receive energy consumption information, the energy consumption information including indications of energy consumption corresponding to the plurality of computing resources, and a routing module configured to route a work request to one of the plurality of computing resources based at least in part on the received utilization information and the received energy consumption information to minimize energy costs of the plurality of computing resources.

Embodiments in accordance with the present invention further provide a computer-implemented method for automated routing of work requests in a distributed computing system. The computer-implemented method includes receiving resource utilization information, the resource utilization information including indications of utilization corresponding to a plurality of computing resources, receiving energy consumption information, the energy consumption information including indications of energy consumption corresponding to the plurality of computing resources, and routing a work request to one of the plurality of computing resources based at least in part on the received utilization information and the received energy consumption information to minimize energy costs of the plurality of computing resources.

Embodiments in accordance with the present invention further provide a computer readable medium storing computer readable instructions when executed by a processor to perform a method that includes receiving resource utilization information, the resource utilization information including indications of utilization corresponding to a plurality of computing resources, receiving energy consumption information, the energy consumption information including indications of energy consumption corresponding to the plurality of computing resources, and routing a work request to one of the plurality of computing resources based at least in part on the received utilization information and the received energy consumption information to minimize energy costs of the plurality of computing resources.

The present invention can provide a number of advantages depending on a particular configuration. First, embodiments of the present invention provide an adaptive mechanism that uses strategic Avaya Aura® and Avaya Experience Manager® contact center architecture to intelligently route work requests to minimize an energy cost associated with operating the contact center. Avaya Aura® and Avaya Experience Manager® are core communication platforms supporting unified communications and contact center solutions for enterprises. Although Avaya® systems are used in this application for illustrative purposes, it should understood by one of ordinary skill in the art that any communications platform or for that matter contact center platform that supports customer-agent interaction monitoring and contact center solutions is contemplated by the present invention and the Avaya® systems are used by way of example only and for simplicity of explaining embodiments of the present invention.

Embodiments of the present invention apply advanced work assignment technology, e.g., Avaya Experience Manager® to make real-time decisions related to minimizing the energy costs associated with operating the contact center. For example, work requests may be routed to a computing resource having the lowest energy costs footprint. As another example, power management instructions to computing resources in the contact center may be generated to reduce the overall energy cost associated with operating the contact center.

Furthermore, the present disclosure is applicable in any enterprise in addition to a traditional contact center. Said differently, any enterprise including distributed computing systems wherein an energy cost of operating the distributed computing system is desired may use embodiments of the present disclosure to automatically route work requests within the system.

These and other advantages will be apparent from the following disclosure.

The preceding is a simplified summary of the present disclosure to provide an understanding of some aspects of various embodiments detailed herein. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible, utilizing one or more of the features set forth above or described in detail below.

### BRIEF DESCRIPTION OF THE DRAWINGS

The above and still further features and advantages of the present disclosure will become apparent upon consideration of the following detailed description of embodiments thereof, especially when taken in conjunction with the accompanying drawings, and wherein:

FIG. 1 is a block diagram depicting an illustrative distributed computing system according to an embodiment of the present disclosure;

FIG. 2 is a block diagram of an energy minimizing engine according to an embodiment of the present disclosure; and

FIG. 3 is a flowchart of a method for routing work requests in a distributed computing system, in accordance with an embodiment of the present disclosure.

The headings used herein are for organizational purposes only and are not meant to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the present invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “computing resource” as used herein should be understood to include any computing devices, such as, for example, a server, a workstation, a laptop, a tablet computer, smart phone, or otherwise any processor-based device configured to execute instructions.

The term “distributed computing system” as used herein should be understood to include any system having multiple computing resources configured to operate within the system.

The term “work request” as used herein should be understood to include any processing request made to the distributed computing system.

The term “energy cost” as used herein should be understood to include the overall energy consumption, the price of the energy consumed, and/or a combination of the overall energy consumption and the price of the energy consumed.

The term “powered down” as used herein should be understood to include any power management operation where utilization of a computing resource is reduced. Additionally, the term powered down as used herein should be understood to include any operation where energy consumption of a computing resource is reduced.

The present disclosure will be illustrated below in conjunction with an exemplary distributed computing system in the form of a contact center, e.g., the Avaya Aura® and/or Avaya Experience Manager® systems. Although well suited for use with, e.g., a distributed computing system having contact processing hardware and/or software, the present disclosure is not limited to any particular type of system or configuration of system elements. Those skilled in the art will recognize the disclosed techniques may be used in any distributed computing system in which it is desirable to minimize the energy costs of operating the system.

For example, the present disclosure may be applied to any of a variety of distributed computing systems that include multiple computing resources. These multiple computing resources may be distributed across any number of different physical sites around the world. Accordingly, the present disclosure may be applied to route work assignments (e.g., processing requests, or the like) to the computing resources to minimize energy costs associated with operating the distributed computing system. In particularly illustrative examples, the present disclosure may be applied to minimize the energy costs associated with operating distributed data centers, distributed cloud computing environments, or otherwise any system that includes multiple computing resources that are configured to process work requests. Accordingly, although the present disclosure frequently refers to an example contact center, it is to be appreciated this is not intended to be limiting and a distributed computing system as described above may be substituted for the example contact center.

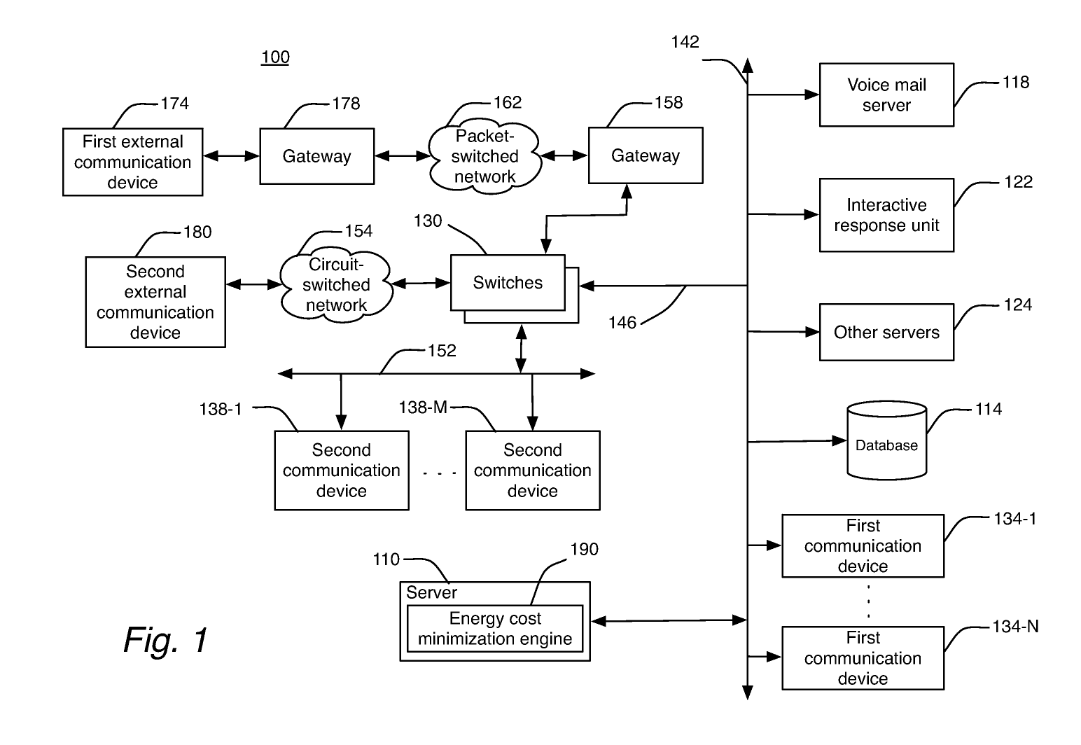

FIG. 1 shows an illustrative distributed computing system in which the present disclosure may be implemented. The distributed computing system is illustrated using an example contact center 100, which comprises a server 110 (described in greater detail below), a set of data stores or databases 114 containing contact or customer related information, system resource information, energy cost information, and/or other information that can enhance the value and efficiency of minimizing the energy costs of operating the contact center, and a plurality of computing resources (e.g., servers and/or communication devices) namely a voice mail server 118, an Interactive Response unit (e.g., IVR) 122, and other servers 124, switches 130, a combination of agents operating packet-switched (first) communication devices 134-1 to N (such as computer work stations or personal computers), and/or circuit-switched (second) communication devices 138-1 to M, all interconnected by a local area network LAN (or wide area network WAN) 142.

The components of the contact center 100 can be connected via optional communication lines 146 to the switches 130. As will be appreciated, the other servers 124 can also include a scanner (which is normally not connected to the switches 130 or Web server), VoIP software, video call software, voice messaging software, an IP voice server, a fax server, a web server, an email server, social networking servers, work request processing servers, and the like. The switches 130 are connected via a plurality of trunks to the Public Switch Telephone Network or PSTN 154 and via link(s) 152 to the second communication devices 138-1 to M. A gateway 158 is positioned between the switches 130 and the packet-switched network 162 to process communications passing between the switches 130 and the network 162.

As stated above, a combination of agents operate the first and second communication devices 134-1 to 134N and 138-1 to 138-M. During operation of the contact center 100, agents operating first communication devices 134-1 to N and/ or second communication devices 138-1 to M engage in interactions, i.e., customer-agent interactions, with customers contacting the contact center. The customers may use first and second external communication devices 174 and 180 to contact the contact center. It is to be appreciated, that the external communication devices are shown in a quantity to facilitate understanding and that in practice, more than two external communication devices will typically be provided. As such, the number of illustrated external communication devices is not intended to be limiting.

It is also to be appreciated that the contact center 100 may be used to process a variety of types of customer communications (i.e., work requests), such as, for example, voice communications, email communications, text message communications, instant message communications, social network communications, or otherwise any communication where a customer desires to communicate with or otherwise interact with a company.

The server 110 can be any architecture for routing work requests to computing resources. In general, the server 110 may route incoming customer contacts to agents (e.g., live agents, automated agents, or the like). For example, the server 110 routes incoming work requests to computing resources of the contact center 100 (described in greater detail below). The computing resources may then respond to (or be used to respond to in the case of computing resources operated by live agents) and/or address the customer communication.

For example, the work requests may be routed to any one of the first communication devices 134-1 to 134-N, the second communication devices 138-1 to 138-M, the voice mail server 118, the interactive response unit 122, or the other servers 124. As will be appreciated, these computing resources may be distributed across multiple physical sites. For example, the first communication devices 134-1 to 134-N may be located at a first site while the second communication devices 138-1 to 138-M may be located at a second site.

The switches 130 can be any architecture for establishing interactions between customers contacting the contact center and computing resources of the contact center. More specifically, the switches 130 may establish customer-agent interactions corresponding to the work requests as routed by the server 110. Illustratively, the switch and/or server can be a modified form of the subscriber-premises equipment sold by Avaya Inc. under the names Definity™ Private-Branch Exchange (PBX)-based ACD system, MultiVantage™ PBX, Communication Manager™, S8300™ media server and any other media servers, SIP Enabled Services™, Intelligent Presence Server™, and/or Avaya Interaction Center™, and any other products or solutions offered by Avaya or another company.

As noted, the contact center 100 may be distributed across multiple physical sites. In such examples, each of the sites may include at least one of the switches 130 and one or more computing resources (e.g., the various servers and/or communication devices) described above. Said differently, each of the computing resources in the contact center 100 may be connected and accessible through one of the switches 130. Accordingly, each of the switches (e.g., located at different sites, located at the same site, or the like) may provide some of the overall contact center features or capacity for processing customer contacts.

As will be more fully described herein, the server 110 may route work request to computing resources in the contact center 100, which may include routing work request to one of the switches 130 or to one of the computing resources connected to one of the switches.

Typically, the switches 130 and server 110 will be a stored-program-controlled system that conventionally includes interfaces to external communication links, a communications switching fabric, service circuits (e.g., tone generators, announcement circuits, etc.), memory for storing control programs and data, and a processor (i.e., a computer) for executing the stored control programs to control the interfaces and the fabric and to provide the automatic monitoring assignment functionality described herein. Other types of known switches and servers are well known in the art and therefore not described in detail herein.

In operating the contact center 100, it is often desirable to minimize the energy costs associated with running all of the computing resources. For example, it may be desirable to minimize the amount of energy consumed to ensure that energy consumption is at or below a specific target. It may be desirable to minimize the price associated with the energy consumed. More specifically, where the computing resources are distributed across multiple physical sites, the price per unit of energy consumed at each site may differ.

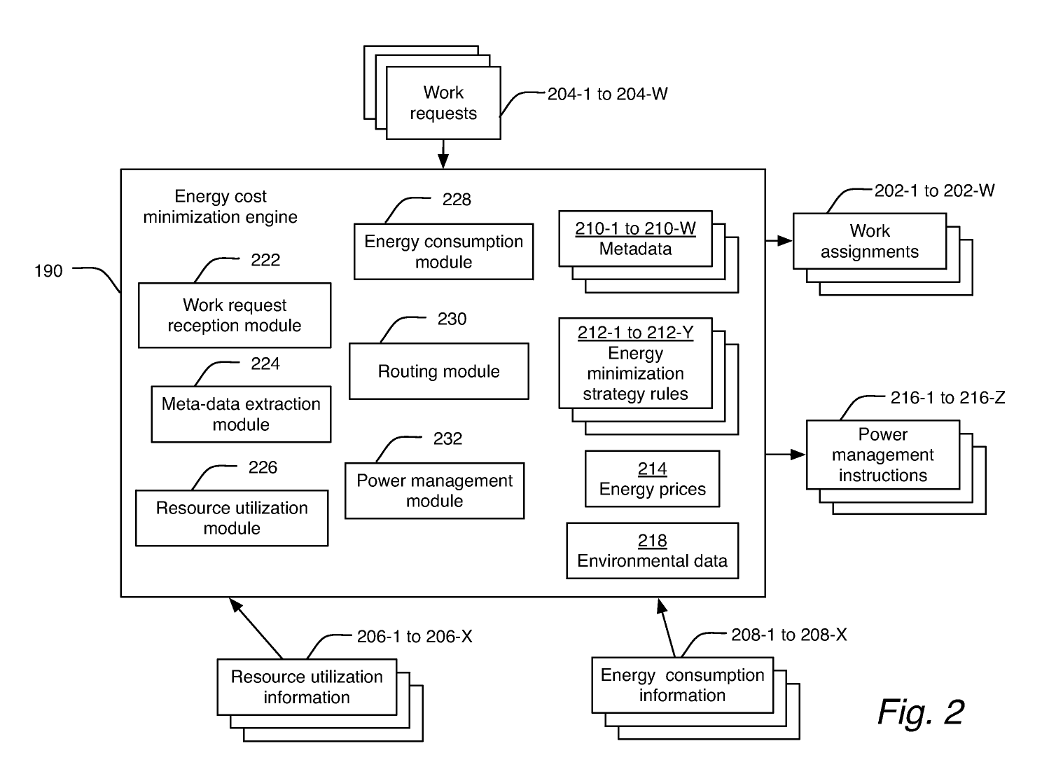

Accordingly, work assignments may be routed to the computing resources to minimize the overall price paid for energy consumed by operating the contact center 100. The server 110 includes an energy cost minimization engine 190 (explained in greater detail below with reference to FIG. 2) to route work requests within the contact center 100 to minimize energy costs of operating the contact center 100. Additionally, the energy cost minimization engine 190 may manage power consumption features of the computing resources in the contact center 100.

Although this embodiment is discussed with reference to client-server architecture, it is to be understood the principles of the present invention apply to other network architectures. For example, the present invention applies to peer-to-peer networks, such as those envisioned by the Session Initiation Protocol or SIP. In the client-server model or paradigm, network services and the programs used by end users to access the services are described. The client side provides a user with an interface for requesting services from the network, and the server side is responsible for accepting user requests for services and providing the services transparent to the user. By contrast, in the peer-to-peer model or paradigm, each networked host runs both the client and server parts of an application program. Additionally, embodiment of the present invention do not require the presence of packet- or circuit-switched networks.

In some examples, the gateway 158 can be Avaya Inc.'s, G700 Media Gateway™ and may be implemented as hardware such as via an adjunct processor (as shown) or as a chip in the server.

In some examples, the first communication devices 134-1 to 134-N are packet-switched and can include, for example, IP hardphones such as the Avaya Inc.'s, 4600 Series IP Phones™, IP softphones such as Avaya Inc.'s, IP Softphone™, Personal Digital Assistants or PDAs, Personal Computers or PCs, laptops, packet-based H.320 video phones and conferencing units, packet-based voice messaging and response units, packet-based traditional computer telephony adjuncts, peer-to-peer based communication devices, and any other communication device.

In some examples, the second communication devices 138-1 to 138-M are circuit-switched. Each of the communication devices 138-1 to 138-M corresponds to one of a set of internal extensions Ext1 to ExtM, respectively. The second communication devices can include, for example, wired and wireless telephones, PDAs, H.320 videophones and conferencing units, voice messaging and response units, traditional computer telephony adjuncts, and any other communication device.

It should be noted that the present disclosure does not require any particular type of information transport medium between a switch or server and first and second communication devices, i.e., the present invention may be implemented with any desired type of transport medium as well as combinations of different types of transport channels.

The packet-switched network 162 can be any data and/or distributed processing network, such as the Internet. The network 162 typically includes proxies (not shown), registrars (not shown), and routers (not shown) for managing packet flows.

The packet-switched network 162 is in communication with the external communication device 174 via a gateway 178; and the circuit-switched network 154 is in communication with the external communication device 180.

In one configuration, the central server 110, network 162, and first communication devices 134 are Session Initiation Protocol or SIP compatible and can include interfaces for various other protocols such as the Lightweight Directory Access Protocol or LDAP, H.248, H.323, Simple Mail Transfer Protocol or SMTP, IMAP4, ISDN, E1/T1, and analog line or trunk.

It should be emphasized that the configuration of the switch, server, communication devices, and other elements as shown in FIG. 1 is for purposes of illustration only and should not be construed as limiting the present disclosure and the foregoing claims to any particular arrangement of elements. Particularly, as stated, embodiments of the present disclosure may be implemented in a variety of different types of distributed computing systems and is not limited to contact centers.

FIG. 2 illustrates an embodiment of the energy cost minimization engine 190. As depicted, the engine 190 is configured to route work requests to computing resources, in the form of generating work assignments 202-1 to 202-W. The work assignments 202-1 to 202-W correspond to the assignment of work requests 204-1 to 204-W (e.g., customers contacting the contact center) to computing resources at the contact center based on utilization metrics of the computing resources (e.g., computing resource utilization 206-1 to 206-X), power consumption metrics of the computing resources (e.g., computing resource power consumption 208-1 to 208-X), work request metadata 210-1 to 210-W, energy minimization strategy rules 212-1 to 212-Y, and/or energy prices 214. Additionally, the energy cost minimization engine 190 may generate power management instructions 216-1 to 216-Z for one or more of the computing resources at the contact center.

The energy cost minimization engine 190 may be configured to receive work requests 204. The energy cost minimization engine 190 may include a work request reception module 222 configured to receive the work requests 204-1 to 204-W. For example, the engine 190 may be notified via LAN 142 of an incoming customer contact by the communications component (e.g., switches 130, instant message server, text message server, web server, and/or other server) through which the customer contact enters the contact center 100. The incoming customer contact may then be added to the work requests 204-1 to 204-W.

The engine 190 may further be configured to extract metadata related to the work requests 204 and save the metadata as work request metadata 210-1 to 210-W. In general, each work request 204 will have at least one piece of metadata associated with it. In practice, however, each work request 204 may have a number of pieces of metadata associated with it. The work request metadata 210-1 to 210-W (also referred to herein as “metadata”) may be any information related to the work request 204. In particular, the metadata 210-1 to 210-W may be information corresponding to type of customer contact corresponding to the work request.

In some examples, the metadata 210-1 to 210-W may include one or more skills associated with the work request. The skills may correspond to knowledge about products, processes, access to customer information (e.g., billing, sensitive records, or the like.) In some examples, the metadata 210-1 to 210-W may include a duration of the customer contact. The duration may correspond to the time the customer has been in contact with the contact center 100, the number of times the customer has contacted the contact center in a specified period of time, or the like. In some examples, the metadata 210-1 to 210-W may include keywords identified by an analytic engine, such as, a speech analytic engine. In some examples, the metadata 210-1 to 210-W may include information about the customer, such as, for example, length of time customer has had an account, metrics associated with the customer's value to an organization, or the like.

The engine 190 may further be configured to receive computing resource utilization information 206. The engine 190 may include a resource utilization module 226 configured to receive information indicating an amount of utilization of each of the computing resources in the contact center 100. In general, the resource utilization information may include indications of the amount of utilization of each of the computing resources in the contact center 100. For example, the utilization information may include indications of the amount of processing power, memory usage, network bandwidth, cooling resource usage, or the like. With some examples, the utilization information may be in the form of metrics, statistics, or the like.

In some examples, the resource usage may be received from each of the computing resources in the contact center 100. With some examples, as stated, each of the computing resources in the contact center 100 may be connected and accessible through one of the switches 130. Accordingly, the resource utilization module 226 may receive resource utilization information from the switches 130. Each of the switches 130 may report on the resource utilization for the computing resources connected to that particular switch.

The engine 190 may further be configured to receive computing resource energy consumption information 208. The engine 190 may include an energy consumption module 228 configured to receive information indicating an amount of energy being consumed by of each of the computing resources in the contact center 100.

In general, the energy consumption information may include indication of the amount of energy consumed by each of the computing resources in the contact center. For example, the energy consumption information may include the units of energy currently being consumed, the average units of energy consumed over a period of time, or the like. With some examples, the consumption information may be in the form of metrics, statistics, or the like. In some examples, the energy consumption may be received from the computing resources in the contact center 100. With some examples, the energy consumption information may be received from the switches 130 (e.g., as described above in conjunction with the resource utilization information). With some examples, the energy consumption information is derived by the energy consumption module 228 based at least in part on the received resource utilization information 206 and known characteristics about the computing resources. For example, the energy consumption module 228 may determine that energy utilization for a particular computing resource based on the known utilization of the resource and known and/or assumed characteristics about energy consumption per utilization statistic.

The modules 226 and 228 may receive the utilization information and the consumption information from a variety of sources, including without limitation, operating systems APIs that expose environmental metrics of the disk and CPU, software and/or hardware utilities that expose their own power management consoles, network and/or UPS infrastructure, wall power meters, or the like.

As stated, the engine 190 is configured to route work requests (e.g., customer contacts) to computing resources (e.g., agents) to minimize energy costs of the contact center 100. In general, work request may be routed to minimize the amount of energy consumed by the computing resources, the price per unit of energy consumed, or some combination of the amount of energy consumed and the price per unit of energy consumed. In some examples, the work requests may be routed to reduce the average price of all energy consumed by the contact center 100. The engine 190 may include a routing module 230 to route work request 204 and generate corresponding work assignments 202. In general, the routing module 230 routes a work request 204 to one of the computing resources in the contact center 100 based on the metadata 210 corresponding to the work requests, the resource utilization information 206-1 to 206-X, the energy consumption information 208-1 to 208-X, the strategy rules 212-1 to 212-Y, and/or the energy prices 214.

In some examples, the work assignments may indicate that a work request is to be routed to a particular computing resource in the contact center 100. With some examples, the work assignments may indicate that a work request is to be routed to a switch 130 in the contact center 100. Said differently, the routing module 230 may assign work requests 204 to switches 130. The switches 130 may then route the work request to a computing resource that is connected to the switch 130. Various examples of routing a work request and thereby generating a work assignments are provided below, however, in general, work requests are routed based at least in part on the energy minimization strategy rules, which as detailed below, may specify conditions regarding how various work requests should be routed.

Furthermore, in some examples, the routing module 230 may further cause the work request to be passed to the switch and/or computing resource (e.g., by transferring the work request to the appropriate switch 130, by causing the appropriate switch 130 to establish a customer-agent interaction for the work request, by adding the work request to a queue of the switch and/ or computing resource, or the like).

In some examples, the engine 190 may also be configured to generate power management instructions 216 for the computing resources (e.g., servers, communication devices, switches, or the like) in the contact center 100. The engine 190 may include a power management module 232 to determine power management instructions for one or more of the computing resources in the contact center 100. In general, the power management module 232 generates power management instructions 216-1 to 216-Z based on the metadata 210 corresponding to the work requests, the resource utilization information 206-1 to 206-X, the energy consumption information 208-1 to 208-X, the strategy rules 212-1 to 212-Y, and/or the energy prices 214. Various examples of power management instructions are provided below, however, in general, power management instructions are generated based at least in part on the energy minimization strategy rules, which as detailed below, may specify conditions regarding how various computing resources should implement power management functions.

As stated above, with some examples, the contact center 100 may be distributed across multiple sites (e.g., located in different buildings, located in different portions of a country, located in different countries, located in different time zones, or the like). In such examples, each site includes at least one of the switches 130 and one or more of the servers and/or communication devices of the contact center 100. Each site may be engineered to handle a specific capacity (e.g., number of simultaneous customer contacts, or the like) plus some level of contingency for spikes in demand. Each of the switches 130 may also include additional hardware and/or software to ensure the switch and connected components are highly available in the event of a failure. More specifically, the switches should be available to handle spikes in demand for contact center services or to handle failures at other switches. The engine 190, however, may be configured to route work requests and generate power management instructions such that ones of the switches 130 and connected computing resources may be powered down (e.g., placed into low power mode, placed into sleep mode, non-essential peripherals turned off, or the like). In particular, ones of the switches 130 and connected computing resources may be powered down without jeopardizing the availability and or redundancy of the contact center 100.

For example, the strategy rules 212-1 to 212-Y may specify that work requests 204 should preferentially be routed to one of the switches 130 and/or computing resources in the contact center (e.g., by routing the work request 204 to one of the switches 130, by routing the work request through one of the switches 130 to a computing resource, or the like) in order to allow one or more of the switches and/or computing resources (e.g., those not currently being routed work requests, or the like) to be powered down. As the computing resources are powered down, power management utilities can stop disks, shutdown processors and/or cores in the case of multi-processor systems or multi-core processors and potentially entirely shut down computing resources to reduce the energy costs of the contact center 100. Furthermore, power management instructions can be generated for ones of the computing resources to be powered down. Said differently, the engine 190 may generate an instruction for one of the computing resources to be cause the computing resource to power down. As another examples, the power management instructions may enable or disable “on-board” power management functions. That is, functions built into or loaded onto individual computing resources may be enabled and/or disabled via power management instructions generated by the engine 190.

In some examples, the strategy rules 212-1 to 212-Y may specify that as demand of the contact center increases, the engine 190 should generate power management instructions to power up ones of the computing resources and route work requests to those computing resources that are already powered up until the newly powered up computing resources are available. Accordingly, sudden spikes in demand (e.g., call volume traffic, or the like) may not cause the contact center to be without sufficient capacity to handle the volume. Furthermore, some of the strategy rules 212-1 to 212-Y may specify ranges of demand where computing resources will be powered down and up in order to reduce the potential for oscillations between powered down and powered up states.

In some examples, the strategy rules 212-1 to 212-Y may specify that work requests should be routed away from computing resources running at a particular utilization (e.g., maximum utilization, greater than 80% utilization, or the like). With some examples, the strategy rules 212-1 to 212-Y may specify that work requests should be routed to computing resources such that all computing resources that are powered up have a particular utilization (e.g., between 60% and 85% utilization, or the like). As will be appreciated, computing resources operating at high utilization (e.g., CPU and Disk I/O near maximum) will proportionally consume more power and produce more heat than a computing resource having normal utilization. Accordingly, the engine 190 may be configured to ensure that each computing resource is running in its “sweet spot” and thus reducing energy consumption and likely hood to fail under stress.

In some examples, the strategy rules 212-1 to 212-Y may specify that work requests are to be routed to computing resources with the lowest price per unit of energy (e.g., as specified by the energy prices 214). It is to be appreciated, that the energy prices 214 may specify the prices paid for electricity, the prices paid for fuel, or the like at various geographic locations where the computing resources are located. In some examples, the strategy rules 212-1 to 212-Y may specify that work requests are to be routed to computing resources with the lowest energy consumption. Accordingly, the amount of energy consumed by the contact center and/or the price paid for the energy consumed may be reduced.

Additionally, the strategy rules 212-1 to 212-Y may specify that work requests are to be routed based at least in part on environmental data 218. As will be appreciated, there are many potential sources for environmental data (e.g., weather, geographic location of the computing resource, current time where the computing resource is located, or the like). The engine 190 may be configured to route work requests based on this environmental data. For example, the strategy rules 212-1 to 212-Y may specify that weather at a geographic location could be taken into account where increases in external temperatures could mean increases in the cost of cooling computing resources. Additionally, energy prices 214 could be used as an added qualification to deciding whether to route work requests to computing resources having high heating\cooling costs as determined by the environmental data 218. Additionally, environmental data 218 may include alerts indicating power outages for sites where computing resources are located. As such, the engine 190 may route work requests away from computing resources that are running on reserve power and/or generators.

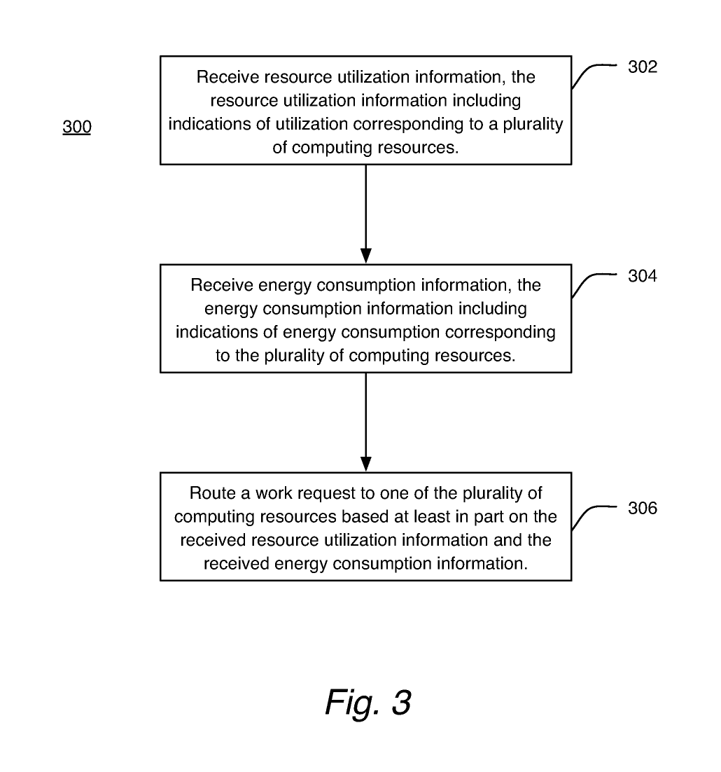

FIG. 3 is a flowchart of a method 300 for routing work requests in a distributed computing system to minimize the energy costs associated with operating the distributed computing system. Although the method 300 is described with reference to the engine 190 and the contact center 100, this is not intended to be limiting. At block 302, receive resource utilization information, the resource utilization information including indications of utilization corresponding to a plurality of computing resources; the resource utilization module 226 receives the resource utilization information 206-1 to 206-Y from the switches 130 and/or the computing resources in the contact center 100.

At block 304, receive energy consumption information, the energy consumption information including indications of energy consumption corresponding to the plurality of computing resources; the energy consumption module 228 receives the energy consumption information 208-1 to 208-X from the switches 130 and/or the computing resources in the contact center 100.

At block 306, route a work request to one of the plurality of computing resources based at least in part on the received resource utilization information and the received energy consumption information; the routing module 230 routes a work request (e.g., one of the work requests 204-1 to 204-W) to one computing resources in the contact center 100. In some examples, at block 306, the routing module 230 routes the work request to one of the switches 130 connected to the one of the plurality of computing devices.

The exemplary systems and methods of this present disclosure have been described in relation to a contact center. However, to avoid unnecessarily obscuring the present disclosure, the preceding description omits a number of known structures and devices. This omission is not to be construed as a limitation of the scope foregoing claims. Specific details are set forth to provide an understanding of the present disclosure. It should however be appreciated that the present disclosure may be practiced in a variety of ways beyond the specific detail set forth herein.

Furthermore, while the exemplary embodiments of the present disclosure illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

For example in one alternative embodiment, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system for automated routing of work requests to computing resources in a distributed computing system, the system comprising:
a resource utilization module configured to receive resource utilization information, the resource utilization information including indications of utilization corresponding to a plurality of computing resources;
an energy consumption module configured to receive energy consumption information, the energy consumption information including indications of energy consumption corresponding to the plurality of computing resources; and
a routing module configured to route a work request to one of the plurality of computing resources based at least in part on the received utilization information and the received energy consumption information to minimize energy costs of the plurality of computing resources.

2. The system of claim 1, wherein the resource utilization information and the energy consumption information are received from a plurality of switches connected to the plurality of computing resources.

3. The system of claim 2, wherein the routing module is further configured to route the work request to one of the plurality of switches.

4. The system of claim 1, wherein the resource utilization information and the energy consumption information are received from the plurality of computing resources.

5. The system of claim 1, further comprising a power management module configured to generate power management commands for at least one of the plurality of computing resources based at least in part on the received resource utilization information and the received energy consumption information.

6. The system of claim 1, wherein the routing module is further configured to route the work request to the one of the plurality of computing resources based at least in part on one or more energy minimization strategy rules.

7. The system of claim 6, wherein the routing module is further configured to route the work request based at least in part on energy prices.

8. The system of claim 7, wherein the routing module is further configured to route the work requests to the one of the plurality computing resources having the lowest energy consumption to minimize the amount of energy consumed by the plurality of computing resources.

9. The system of claim 7, wherein the routing module is further configured to route the work requests to the one of the plurality of computing resources having the lowest energy price to minimize the price per unit of energy consumed by the plurality of computing resources.

10. The system of claim 6, wherein the routing module is further configured to route work requests to ones of the plurality of computing resources having corresponding resource utilization within a specified range.

11. The system of claim 6, wherein the routing module is further configured to not route work requests to ones of the plurality of computing resources having corresponding resource utilization greater than a specified level.

12. The system of claim 1, wherein the system is a contact center.

13. The system of claim 1, wherein the system if a cloud computing system.

14. A computer-implemented method for automated routing of work requests in a distributed computing system, the method comprising:
receiving resource utilization information, the resource utilization information including indications of utilization corresponding to a plurality of computing resources;
receiving energy consumption information, the energy consumption information including indications of energy consumption corresponding to the plurality of computing resources; and
routing a work request to one of the plurality of computing resources based at least in part on the received utilization information and the received energy consumption information to minimize energy costs of the plurality of computing resources.

15. The method of claim 14, further comprising receiving the resource utilization information and the energy consumption information from a plurality of switches connected to the plurality of computing resources.

16. The method of claim 15, wherein routing the work request to the one of the plurality of computing resources includes routing the work request to one of the plurality of switches.

17. The method of claim 14, further comprising receiving the resource utilization information and the energy consumption information are received from the plurality of computing resources.

18. The method of claim 14, generating power management commands for a one of the plurality of computing resources based at least in part on the received resource utilization information and the received energy consumption information.

19. The method of claim 14, further comprising routing the work request to the one of the plurality of computing resources based at least in part on one or more energy minimization strategy rules.

20. The method of claim 19, further comprising routing the work request to the one of the plurality of computing resources based at least in part on energy prices.

21. The method of claim 19, further comprising:
identifying a one of the plurality of computing resources having a corresponding resource utilization within a specified range; and
routing the work request to the identified one of the plurality of computing resources.

22. The method of claim 19, further comprising:
identifying a one of the plurality of computing resources having a corresponding resource utilization below a specified level; and
routing the work request to the identified one of the plurality of computing resources.

23. The method of claim 19, further comprising determining metadata corresponding to the work request, wherein the work request is routed based at least in part on the determined metadata.

24. A computer readable medium storing computer readable instructions when executed by a processor perform a method comprising:
receiving resource utilization information, the resource utilization information including indications of utilization corresponding to a plurality of computing resources;
receiving energy consumption information, the energy consumption information including indications of energy consumption corresponding to the plurality of computing resources; and
routing a work request to one of the plurality of computing resources based at least in part on the received utilization information and the received energy consumption information to minimize energy costs of the plurality of computing resources.
